(19) United States
(12) Patent Application Publication
(10) Pub. No.: US 2009/0007104 A1
(43) Pub. Date: Jan. 1, 2009

(54) PARTITIONED SCHEME FOR TRUSTED PLATFORM MODULE SUPPORT

(76) Inventors: Vincent J. Zimmer, Federal Way, WA (US); Michael Rothman, Puyallup, WA (US)

Correspondence Address: SCHWEGMAN, LUNDBERG & WOESSNER, P.A., P.O. BOX 2938, MINNEAPOLIS, MN, 55402, US

(21) Appl. No.: 11/771,841

(22) Filed: Jun. 29, 2007

(51) Int. Cl. G06F 9/455

(52) U.S. Cl. 718/1

(57) ABSTRACT

The subject mater herein relates to processing of sensitive data and, more particularly, to a partitioned scheme for trusted platform module support. Various embodiments provide systems, methods, and software that instantiate one or more emulated trusted platform modules in respective sequestered processor cores. In some embodiments, a trusted platform module in instantiated in a processor core, sequestered for the trusted platform module, for each operating system or virtual machine operating on a computing device. The operating system may then communicate with the appropriate trusted platform module over a secure communication channel, such as an interpartition bridge.

### TECHNICAL FIELD

The subject mater herein relates to processing of sensitive data and, more particularly, to a partitioned scheme for trusted platform module support.

### BACKGROUND INFORMATION

A trusted platform module (“TPM”) generally is a discrete microcontroller that can store secure information within a computer system or device built into a chipset. A TPM offers facilities for generation of cryptographic keys, the ability to limit the use of keys, as well as a random number generator. The keys may include keys such as an Endorsement Key or a Storage Root Key that allows secure access to the computer system to minimize risks of losing or compromising important information from hacking, viruses, worms, and the like,

The purpose of a TPM is to keep sensitive information out of memory and the control of software. When a virtual machine monitor, such as a hypervisor is implemented on a computing device, the TPM needs to be virtualized to allow each virtual machine access to it. However, this may bring the sensitive information of the TPM into memory and under the control of software.

### BRIEF DESCRIPTION OF THE DRAWINGS

FIG. 1 illustrates an example embodiment of a processing system in the form of a software layer with runtime environments and a hardware layer with various hardware resources.

FIG. 2 depicts an example embodiment of a system to launch one or more trusted, runtime environments that coexist with a main runtime environment within a protected core prior to launching an OS in the main runtime environment.

FIG. 3 is a block flow diagram of a method according to an example embodiment.

### DETAILED DESCRIPTION

Generally, methods and arrangements to launch two or more trusted, distinct, co-existing environments are contemplated. Embodiments may launch two or more trusted, co-existing environments in pre-operating system (“OS”) space with high assurance. Each trusted environment or partition may be assigned hardware resources that are isolated from other processing system resources via a hardware-enforced isolation scheme to facilitate storage and execution of code and data. In many embodiments, the system may launch a partition manager to establish embedded and main partitions. Embedded or sequestered partitions may not be visible to the main OS and may be used for a wide variety of applications such as host critical operations, I/O offloading, soft peripherals, platform manageability, and/or fault prediction. For instance, an embedded partition may include a runtime for, e.g., EFI, embedded Linux®, Microsoft® Windows® Compact Edition (WinCE), other Real Time Operating Systems (RTOS), and etc., to host critical operations such as a personal video recorder or set-top box, which must vet for premium content download. Trustworthiness in the launch of the embedded partition is established by comparing integrity metrics for the runtime environment against integrity measurements of a trusted runtime environment for the embedded partition. Some embodiments provide one or more embedded trusted platform module (“TPM”) partitions

Upon establishing trustworthiness, content for the embedded partition may be unsealed and additional embedded partitions may be launched before invocation of a main partition. The main partition may host a general purpose OS (e.g., one of the various Windows®-based OSs, a Linux®-based OS, etc.) and one or more user applications (e.g., a web server, a business application, etc.). Trustworthiness may also be established in the launch of the main partition by, e.g., executing authenticated code via firmware and measuring trustworthiness of critical commands with the authenticated code and trusted hardware during operation via, e.g., a trusted platform module (“TPM”). In typical embodiments, the TPM exists in one or more partitioned, cores of a multi-core central processor that is sequestered from other cores of the central processor.

In some embodiments, the embedded and the main partitions may not interact. In other words, operations performed by the embedded partitions) may be independent of operations in the main partition. For example, an embedded partition may act like a “hardware device” such as a network circuit-breaker or a hardware firewall. In typical embodiments, one or more sequestered TPM partitions operate as emulated standalone TPM hardware devices.

However, in other embodiments, a main partition may be communicatively coupled with an embedded partition via a communication channel such as an Inter-Partition Bridge (IPB). The IPB may be a trusted channel of communication that allows two trusted partitions or sub-systems to communicate in accordance with an expected security policy such as cryptographic keys. In several embodiments, the IPB may comprise a shared memory buffer.

Several embodiments implement the platform resource layer (PRL) via a partition manager to configure partitions, hiding resources such as processor units, random access memory (RAM) units, peripheral devices, integrated devices, and the like, from other partitions. In some embodiments, the partition manager may hide resources in accordance with a hardware-enforced isolation scheme by, e.g., modifying the advanced configuration and power interface (ACPI) tables produced by the BIOS, EFI, UEFI, or other firmware. In further embodiments, the partition manager may hide resources from the OS, e.g., by updating device-hide registers or other locations in the system's input/output (I/O) controller hub (ICH). In other embodiments, an embedded partition loader (EP loader) code will be executed by the partition manager and the EP loader code may hide resources as necessary and, upon authentication of the EP loader code, load protected data into the hidden resources.

In some such embodiments, the EP loader code, or other code, may cause one or more processor cores to be partitioned from other cores. These partitioned cores may be partitioned to hide a TPM from other cores and partitions. In some such embodiments, the one or more TPM partitioned cores execute code to essentially virtualize one or more TPMs. The TPM in such embodiments is embedded in a partitioned core and may be accessed as a TPM by authorized requestors. In some embodiments, a processor core is partitioned for each virtual machine operating on top of a virtual machine monitor. In some such embodiments, an instance of the IPB may be instantiated for each TPM partition to provide for a trusted interface specification (“TIS”) memory-mapped channel to the device for each virtual machine, such as a portioned OS. Thus, rather than a virtual machine monitor needing to virtualize access to a TPM and potentially expose sensitive data in memory, sequestered cores of a processor operate as TPM's to keep sensitive data in secured hardware away from rogue users and processes.

While portions of the following detailed discussion describes embodiments with reference to specific configurations and protocols for buses, hardware, software, and other logic, persons of ordinary skill in the art will recognize that embodiments may be implemented with other configurations and in accordance with other protocols to accomplish substantially the same functionality.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

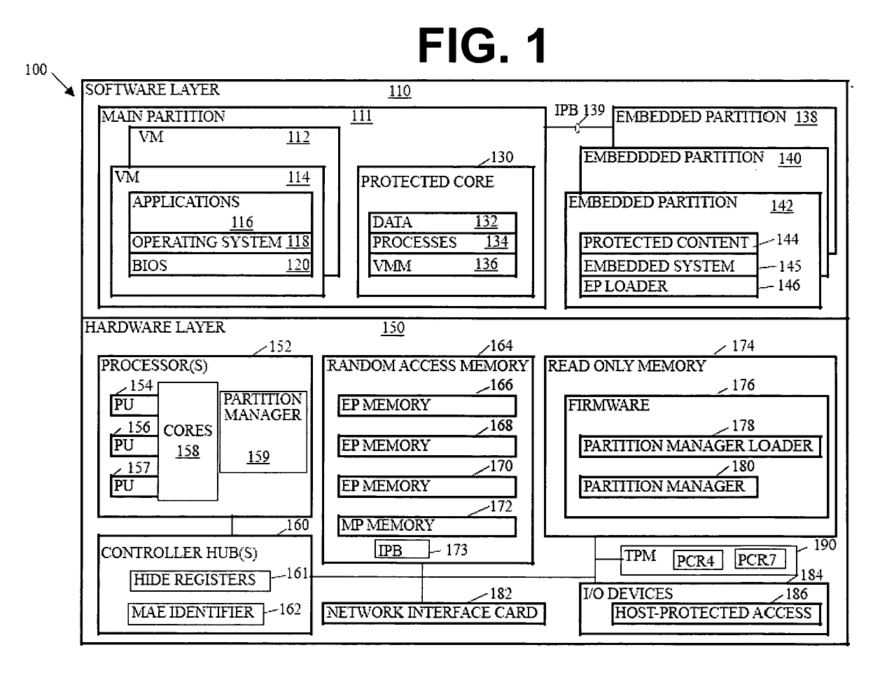

Turning now to the drawings, FIG. 1 illustrates an example embodiment of a processing system 100 in the form of a software layer 110 with runtime environments and a hardware layer 150 with various hardware resources. System 100 is a computer system such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing or transmitting information. Similar embodiments are implemented as, e.g., entertainment devices such as a portable music player or a portable video player, a smart phone or other cellular phone, a telephone, a digital video camera, a digital still camera, an external storage device, or the like. Further embodiments implement larger scale server configurations such as server systems.

With respect to software layer 110, system 100 may establish via partition manager 180 or 159 one or more trusted, coexisting embedded partitions such as embedded partitions 138, 140, and 142. Partition manager 180 or 159 may establish the embedded partitions prior to launching virtual machine monitor (VMM) 136 in a main partition 111 in response to a system boot or reset.

Embedded partitions such as embedded partitions 138, 140, and 142 may utilize processor cores that would not otherwise be used or might be used less efficiently by VMM 136. For instance, for processing systems in which the number of processor cores exceed eight, VMM 136 may be unable to efficiently utilize more than eight cores so eight cores may be allocated to main partition 111 for VMM 136 and the remainder of the cores may be allocated to embedded partitions.

In many embodiments, partition manager 159 or 180 may hide or sequester the embedded partitions 138, 140, and 142 from main partition 111, in particular, partition manager 159 or 180 may hide the hardware resources of the embedded partitions 138, 140, and 142 so those resources are not discoverable by VMM 136.

While embedded partitions 138, 140, and 142 may operate independently from main partition 111, some embodiments offer communication channels between one or more of the embedded partitions and main partition 111. In the present embodiment, the embedded partitions such as embedded partition 138 may communicatively couple with main partition 111 via an inter-partition bridge (IPB) 139. IPB 139 may be a secured or an unsecured channel for communication and may be implemented via hardware such as input-output (I/O) and memory controller hubs or may be a shared memory buffer 173.

Embedded partitions such as embedded partitions 138, 140, and 142 may perform a variety of functions. For example, in some embodiments, embedded partition 142 may be sequestered and may host critical operations such as a personal video recorder or set-top box, which must vet for premium content download. In such embodiments, the processes of protected content 144, which execute within embedded partition 142, may authorize the premium content. Such processes may authorize the premium content internally via the content of host-protected access (HPA) 186 or via secured communications with a remote system via network interface card (NIC) 182.

In some embodiments, embedded partitions such as embedded partitions 138, 140, and 142 may perform trusted platform module (“TPM”) functions. In some such embodiments, a TPM 190 may exist in the hardware layer and hold sensitive data, such as encryption keys. The TPM 190 in such embodiments may emulated within one or more of the partitions 138, 140, 142 and each may be individually made accessible only to one main partition, such as a main partition within which a virtual machine may be operating. In such embodiments, when the TPM 190 is emulated, the TPM 190 may then be sequestered to prevent or restrict access to the TPM 190. In other embodiments, the TPM is embedded within one or more processors 152 such as within a core of the processor.

Embedded partition 142 illustrates an example of the types of software layers that may be present in embedded partitions. In particular, embedded partition 142 comprises protected content 144, embedded system 145, and EP loader 146. Protected content 144 may be content decrypted from HPA 186 upon verification of integrity metrics of the runtime environment of embedded partition 142. The runtime environment of embedded partition 142 may comprise hardware configurations and software configurations associated with embedded partition 142. For example, the runtime environment of embedded partition 142 may comprise EP loader 146 as well as hardware resources such as processor unit (PU) 157 and EP memory 170, which are assigned exclusively to embedded partition 142. In some embodiments, a partition manager such as partition manager 180 or partition manager 159 will load embedded system 145, avoiding the need for a separate EP loader 146.

EP loader 146 may load embedded system 145 from I/O devices 184 and release control to embedded system 145. Embedded system 145 may comprise embedded Linux®, Microsoft® Windows® Compact Edition (WinCE), other Real Time Operating Systems (RTOS), to host operations within embedded system 142. In other embodiments, embedded system 145 may comprise a specialized software designed to perform specific functionality, such as TPM functionality or TPM emulation. For instance, embedded system 145 may comprise software to emulate a graphics accelerator card.

Embedded system 145 may consist of a monolithic package of instructions that is loaded into embedded partition 142 and then provides all or substantially all of the services or functions to be performed by embedded partition 142. For purposes of this disclosure, an embedded system is software that provides the kind of services which are typically provided by a conventional OS (e.g., task scheduling, error handling, I/O services, etc.), as well as services that are typically provided by system firmware (e.g., the discovery and initialization of hardware components, the provision of software interfaces to those components, TPM functionality, etc). An embedded system may also provide services that are typically provided by programs or applications that run on top of an OS,

Once embedded system 145 is loaded, EP loader 146 may request access to protected content 144, which may be stored in HPA 186 or other protected data storage. The TPM 190 may hold a cryptographic key to access protected content 144 as stored in HPA 186 and may verify integrity metrics of the runtime environment of embedded partition 142 prior to releasing the cryptographic key. TPM 190 may comprise cryptographic keys for each of the embedded partitions for system 100 as well as one or more keys associated with establishing a protected core 130 in main partition 111. However, as mentioned above, the TPM 190 may be sequestered to restrict or prevent access. In such instances, the EP loader 146 and HPA 186 are either aware of the location of the appropriate TPM instance or are redirected to the appropriate TPM instance in one or more of the processors 152 or cores.

In many embodiments, a TPM may respond to a request for a key for embedded partition 142 by measuring integrity metrics of the runtime environment of embedded partition 142. In some embodiments, a TPM may also make additional measurements of integrity metrics for system 100. The integrity metrics may comprise, e.g., a hash of an image of the runtime environment of embedded system 142 and system 100 more generally. The measured or current integrity metrics for embedded partition 142 may be extended into a platform configuration register seven (PCR7). PCR7 may be utilized in many embodiments because PCR7 is a register in which the content is designated for manufacture control or use. The TPM may respond to the extension by hashing the integrity metrics with the content of the PCR7. This TPM functionality may be performed by a processor 152 or a portion thereof according to software loaded into the processor 152 or firmware that provides the services of a TPM.

PCR7 may comprise a hash of a trusted image of the runtime environment for embedded system 142. For example, hardware layer 150 may comprise MAE identifier 162 to identify a signal or a short that may be indicative of a manufacturer approved environment (MAE). A TPM may recognize the existence of the manufacturer approved environment and, rather than unsealing a key in response to a extension of the integrity metrics for embedded partition 142 into PCR7, the TPM may generate and seal a key for embedded partition 142 with the integrity metrics. In some embodiments, EP loader 146 may then encrypt protected content 144 in HPA 186 with the key or a corresponding asymmetric key.

When MAE identifier 162 does not indicate that system 100 is in a manufacturer approved environment, the integrity metrics for embedded partition 142 may be hashed with the contents of PCR7 to determine whether the runtime environment of embedded partition 142 is trustworthy or otherwise authenticated. If the hash of the runtime environment of embedded partition 142 verifies the integrity of the environment then the TPM provides the key for protected content 144 in HPA 186 to EP loader 146. EP loader 146 may then load portions of or all of the data and processes stored in HPA 186 into EP memory 170. On the other hand, if the hash indicates that the runtime environment is compromised, the TPM may not unseal the key. Furthermore, partition manager 159 or 180 may launch embedded partitions 138 and 140 in a similar manner substantially simultaneously or in accordance with a defined sequence.

Main partition 111 may host a protected core 130 with a trusted OS kernel such as VMM 136 and one or more virtual machines (VMs) such as VMs 112 and 114. In other embodiments, the trusted OS kernel may be a trusted portion of OS 118 and there may be only one OS runtime environment in main partition 111.

Partition manager 159 or 180 may establish trustworthiness in the launch of the runtime environment for protected core 130 of main partition 111 by authenticating code of VMM 136 via an appropriate TPM instance or by measuring integrity metrics of the runtime environment and comparing the integrity metrics to trusted integrity metrics stored in the appropriate TPM instance. For instance, the hardware environment for main partition 111 may be the remainder of the hardware resources available after assigning resources to the embedded partitions. Partition manager 159 or 180 may authenticate VMM 136 via the appropriate TPM instance and receive a key from that TPM to decrypt data 132 and processes 134. Data 132 and processes 134 may reside in HPA 186 until decrypted and loaded into MP memory 172.

VMM 136 is a low-level OS that offers control of platform partitioning at a logical level. In particular, VMM 136 may establish and manage a number of VMs such as VMs 112 and 114. VMM 136 controls software loads for the additional partitions. In many embodiments, VMM 136 may offer security in the VMs by authenticating code and runtime environments via an emulated TPM in a processor core. The emulated TPM may reside in protected core 130 as data 132 and processes 134. In some embodiments, one or more of the embedded partitions such as embedded partition 140 may host a VMM with one or more VMs. In such embodiments, embedded partition 140 may appear to be a distinct, trusted processing system from main partition 111 that coexists in system 100 but is isolated from main partition 111 via a hardware-based isolation scheme. Such embodiments may efficiently utilize a number of processing cores beyond which a general purpose OS such as OS 118 can easily scale.

Upon configuring VM 114, VMM 136 may load a basic input-output system (BIOS) 120. VMM 136 may then verify the integrity of VM 114 and pass control over software loading to BIOS 120. BIOS 120 may launch OS 118. Each VM can leverage an OS runtime across a number of cores 158, offering several runtime environments in different partitions. For example, VM 114 may host a general purpose OS 118 (e.g., one of the various Windows®-based OSs, a Linux®-based OS, etc.) and one or more user applications 116 (e.g., a web server, a business application, etc.). VM 112 may host similar software.

Hardware layer 150 comprises processor(s) 152, controller hub(s) 160 coupled with random access memory (RAM) 164, read only memory (ROM) 174, a network interface card (NIC) 182, input-output (I/O) devices 184, and, in some embodiments, TPM 190. Processor(s) 152 represent one or more processors for a system such as Intel®'s Pentium® processors, Xeon® processors, Itanium® processors, Celeron® processors, or the like. In the present embodiment, processor(s) 152 comprise multiple processing units, such as processing unit (PU) 154, processing unit 156, and processing unit 157. Processing units 154, 156, and 157 are physical or logical assignments of processing capabilities to embedded partitions 138, 140, and 142. In some embodiments, for instance, processing unit 154 may represent one or more of cores dedicated for usage by the embedded partition 138. Processing unit 156 may represent a logical unit such as a hyper-thread. Main partition 111 may generally manage cores 158 to the extent that they are not hidden or sequestered for embedded partitions 138, 140, and 142.

Cores 158 may comprise partition manager 159 as microcode. Note that many embodiments comprise either a partition manager in firmware 176 of system 100 such as partition manager 180 or a partition manager in microcode of a processor such as partition manager microcode 159. On the other hand, some embodiments may comprise both. Utilization of the partition manager 180 is often referred to as a static root of trust for measurement (SRTM) while utilization of the partition manager 159 is often referred to as a dynamic root of trust for measurement (DRTM).

For SRTM, a chain of trust that is started by computer system reset or reboot, which processor(s) 152 in a known state. The first code executed, the core root of trust for measurement (CRTM), such as partition manager boot 178, measures the next code to be executed, partition manager 180. Once trust is lost such as by recognition of compromised or unknown code, system 100 may be rebooted or reset to regain trust in system 100.

On the other hand, DRTM uses processor instructions to put a core of processor(s) 152 in a known state. Code to be executed is sent to TPM to be measured into a special platform configuration register (PCR), which is accessible only when in the DRTM initialization state and only by one or more cores of the processor(s) 152. Initial, measured DRTM code is protected by hardware. Furthermore, with DRTM, if trust is lost, system 100 can restart the chain of trust without rebooting. An instance of DRTM includes but is not limited to Intel® Trusted Executino Technology (“TXT”).

Processor(s) 152 communicatively couple with RAM 164, ROM 174, NIC 182, I/O devices 184, and TPM 190 via buses and controller hub(s) 160. However, as noted above, some embodiments do not include a TPM 190 as illustrated. The TPM may be embedded in one or more of the processors 152 or processor cores. Processor(s) 152 may also be communicatively coupled with additional components (not shown) of hardware layer 150, such as one or more video controllers, SCSI controllers, network controllers, universal serial bus (USB) controllers, I/O ports, input devices such as a camera, etc. Furthermore, hardware layer 150 may include one or more bridges, such as a peripheral component interconnect (PCI) root bridge, etc., for communicatively coupling system components. As used herein, the term “bus” includes pathways that may be shared by more than two devices, as well as point-to-point pathways. In some embodiments, a TPM may be coupled to a USB controller and then emulated in one or more processors 152 or processor cores.

Controller hub(s) 160 represent a chipset such as Intel®'s 975X Express Chipset, 865P Chipset, 845G Chipset, 855GM Chipset, E7525 Chipset, E8870 Chipset, 852GME Chipset, 537EP Chipset, 854 Chipset, or the like. For instance, controller hub(s) 160 may comprise a memory controller tab and an I/O controller hub.

In the present embodiment, controller hub(s) 160 comprise hide registers 161 and MAE identifier 162. Hide registers 161 may comprise registers used to hide hardware resources of hardware layer 150 for embedded partitions. For example, random access memory for each of the embedded partitions (EP memories 166, 168, and 170) may be hidden by storing a bit or other indicator in hide registers 161. IPB 173 and hardware used for other functionality may also be hidden. Hiding EP memory 166 may, for instance, prevent any partition other than embedded partition 138 from recognizing the existence of that portion of RAM 164.

In some embodiments, controller hub(s) 160 may use configuration constructs to block configuration cycles for certain devices to hide those devices. In further embodiments, ACPI parameters for main partition 111 may be used to hide processing units and one or more portions of RAM 164 from OS 118, while ACPI parameters for embedded partitions such as embedded partitions 138, 140, and 142 may be used to hide processing units and other portions of RAM 164 from embedded systems such as embedded system 145. Additional details about device hide registers and related topics may be obtained from the Intel® I/O Controller Hub 6 (ICH6) Family Datasheet, dated January 2004 (the “ICH6 datasheet”). The ICH6 datasheet may be obtained from http://www.intel.com/design/chipsets/datashts/301473.htm. Additional details about ACPI parameters and related topics may be obtained from Revision 3.0a of the Advanced Configuration And Power Interface Specification, dated Dec. 30, 2005 (the “ACPI specification”). The ACPI specification may be obtained from www.acpi.info/spec.htm.

In alternative embodiments, other data storage constructs within one or more components may be used to disable or hide devices within a processing system, and other techniques may be used to hide processing units 154, 156, and 157, and portions of RAM 164.

RAM 164 may be system memory supporting execution of instructions by processors 152 by storing data and instructions related to applications such as applications, drivers, and other code. RAM 164 may be composed of one or more memory modules and controller hub(s) 160 may include a memory controller with logic for mapping addresses to particular areas of RAM 164. RAM 164 comprises EP memories 166, 168, and 170, MP memory 172, and IPB 173. RAM 164 may also comprise memory reserved or dedicated for other functionality.

ROM 174 may be one or more memory modules of protected storage for firmware 176 and, in some embodiments, other functionality. ROM 174 may include memory or storage such as flash memory, electrically erasable programmable read only memory (EEPROM), magnetic RAM (MRAM), ferroelectric RAM (FeRAM), or the like. Firmware 176 may store code such as partition manager loader 178 and partition manager 180. Partition manager loader 178 may comprise a trusted core loader initiated at boot or reset of system 100 to load and verify the integrity of partition manager 180.

TPM 190 may be a microcontroller that can store secured information. TPM 190 may comprise a chip embedded on the motherboard of system 100 that can be used to authenticate a hardware device or code. The TPM may alternatively exist within one or more processors 152 or processor cores. A TPM offers facilities for secure generation of cryptographic keys, the abilities to limit the use of keys (to either signing/verification or encryption/decryption), as well as a hardware-based random number generator. Features of each TPM may comprise remote attestation, binding, and sealing. Remote attestation may comprise measurement of a runtime environment to create a substantially unforgeable summary of the runtime environment to allow a third party such as a premium content provider to verify that the runtime environment has not been compromised. Sealing may encrypt data in a way that prevents the data from being decrypted unless the runtime environment is substantially the same at the time of decryption. And binding may encrypt data using the TPM Endorsement Key, which may be a unique RSA key put in the chip during its production) or another ‘trusted’ key. RSA is the represents the surnames of Ron Rivest, Adi Shamir and Len Adleman whom publicly described the algorithm.

In the present embodiment, TPM comprises a number of platform configuration registers (PCRs). TPM 190 is illustrated with two of the registers, PCR4 and PCR7, for purposes of the discussion. In other embodiments, TPM 190 may have only two registers. In further embodiments, TPM may access registers external to TPM 190. In embodiments where the TPM 190 is emulated or exists within a processor or one or more processor cores, the TPM utilizes registers within the processor or core or are external to the processor or core.

System 100 may be controlled, at least in part, by input from conventional input devices, such as a keyboard, a pointing device such as a mouse, etc. Input devices may communicate with system 100 via I/O devices 184, for example. I/O devices 184 may be one or more ports for communication with external I/O devices and may comprise I/O devices such as modems, drive controllers, compact disk drives, hard disk drives, more mass storage devices, or the like. The storage devices may include, for instance, integrated drive electronics (IDE), small computer system interface (SCSI), and serial advanced technology architecture (SATA) hard drives. The storage devices may also include other devices or media, such as floppy disks, optical storage, tapes, flash memory, memory sticks, compact flash (CF) cards, digital video disks (DVDs), etc.

System 100 may also respond to directives or other types of information received from other processing systems or other input sources or signals. System 100 may utilize one or more connections to one or more remote processing systems, for example through a network interface controller (NIC) 182, a modem, or other communication ports or couplings. System 100 may interconnect with other systems via a physical and/or logical network, such as a local area network (LAN), a wide area network (WAN), an intranet, the Internet, etc. Communications may utilize various wired and/or wireless short range or long range carriers and protocols, including radio frequency (RF), satellite, microwave, Institute of Electrical and Electronics Engineers (IEEE) 802.11, 802.16, 802.20, Bluetooth, optical, infrared, cable, laser, etc.

Some components, such as NIC 182, for example, may be implemented as adapter cards with interfaces (e.g., a PCI connector) for communicating with a bus. Alternatively, NIC 182 and other devices may be implemented as on-board or embedded controllers, using components such as programmable or non-programmable logic devices or arrays, application-specific integrated circuits (ASICs), embedded processors, smart cards, etc.

For purposes of this disclosure, the term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations. For instance, RAM 164, ROM 174, and I/O devices 184 may include various sets of instructions which, when executed, perform various operations. Such sets of instructions may be referred to in general as software or code.

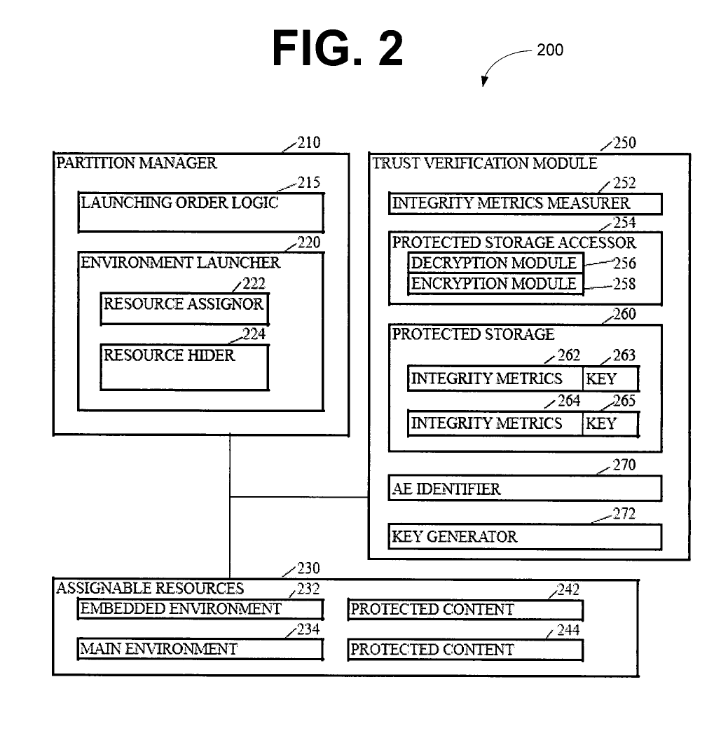

FIG. 2 depicts an example embodiment of a system 200 to launch one or more trusted, runtime environments mat coexist within a main runtime environment with a protected core prior to launching an OS in the main runtime environment. System 200 may comprise a partition manager 210, assignable resources 230, and a trust verification module 250. Partition manager 210 may comprise logic such as code and/or state machines that are designed to provide a core root of trust for measurement of system 200. In particular, partition manager 210 may comprise trustworthy code that can be authenticated via trust verification module 250. Furthermore, partition manager 210 can be trusted to maintain the integrity of a chain of trust for runtime environments and subsequently launched code.

Partition manager 210 may comprise launching order logic 215 and an environment launcher 220. Launching order logic 215 may comprise logic such as hardware and/or software to define an order of operations to launch runtime environments such as embedded environment 232 and main environment 234. Environment launcher 220 may comprise logic to assign hardware resources such as memory units and processing units to environments as well as a code loader to load firmware or an OS into an environment. For instance, launching order logic 215 may initiate operations to configure embedded environment 232 by allocating assignable resources 230 to embedded environment 232. In particular, launching order logic 215 may invoke resource assignor 222 of environment launcher 220 to assign memory units, processor units, and other hardware resources to embedded environment 232. Environment launcher 220 may then load firmware to load an OS into embedded environment 232 or load the OS into embedded environment 232. In many embodiments, resource hider 224 may hide hardware resources of embedded environments. In some embodiments, resource hider 224 may hide the resources after loading the firmware or OS into embedded system 232, while in further embodiments, resource hider 224 may hide the resources before loading and verifying the current integrity metrics of embedded environment 232. Resource hider 224 may hide resources via schemes available in the hardware such as by blocking an OSs ability to discover the resource during initialization of the OS.

Upon loading the firmware or the OS into embedded environment, trust verification module 270 may verify the current integrity metrics of embedded environment 232 against integrity metrics 262 prior to providing the firmware or OS of embedded environment 232 with a key 263 from protected storage 260. If trust verification module 250 verifies the current integrity metrics of embedded environment 232, the firmware or OS of embedded environment 232 may utilize key 263 to decrypt protected content 242 for use within embedded environment 232. In some embodiments, key 263 may also be useful to encrypt and store data and/or processes into protected content 242. In other embodiments, embedded environment 232 may modify content in or encrypt new content for protected content 242 via trust verification module 250.

In several embodiments, launching order logic 215 may at least begin to launch main environment 234 while configuring or launching embedded environment 232. For example, launching order logic 215 may configure main environment 234 substantially simultaneously with configuring embedded partition 232. In further embodiments, launching order logic 215 may begin configuration of main partition 234 after verification of the current integrity metrics of embedded environment 232. In several embodiments, more than one embedded environment such as embedded environment 232 may be configured and/or launched prior to launching an OS in main environment 234.

Launching order logic 215 may initiate the launch of main environment 234 in a manner similar to that of embedded environment 232. For example, launching order logic 215 may instruct environment launcher 220 to configure the hardware resources of main environment 234 and then load code that can be authenticated to initiate a chain of trust within main environment 234. The chain of trust may encompass a protected core within main environment 234 that comprises a trusted OS kernel and trusted processes and/or data from protected content 244.

After establishing and hiding the protected core, an OS may be launched within main environment 234 in resources outside of the protected core. For instance, the OS may be a general purpose OS. In other embodiments, the OS may be a specific purpose OS such as an OS to control mechanical functionality of a digital video recorder (DVR). For example, the DVR may include a hard drive to recorder television shows as well as a protected core with functionality to facilitate access to premium video content. The specific purpose OS may include logic to receive and interpret instructions from a user to play and record digital video content while the OS kernel in the protected core may include functionality to interact with the specific purpose OS to purchase and play premium digital video content. In such embodiments, embedded system 232, may, for instance, comprise logic to download, interpret, and stream the premium digital video content to the protected core.

Assignable resources 230 may represent logical and/or physical hardware resources that may be assigned to a runtime environment such as embedded environment 232 and main environment 234. Assignable resources 230 may include processor cores, RAM, ROM, a memory controller hub, an I/O controller hub, busses, I/O interfaces, and the like.

Assignable resources 230 comprise embedded environment 232, main environment 234, protected content 242, and protected content 244. Embedded environment 232 may represent hardware and code that comprise an embedded runtime environment. Similarly, main environment 234 may comprise hardware and code that make up the main partition of the system 200. Protected content 242 may comprise data and/or processes for use by embedded environment 232 upon verification of the current integrity metrics of embedded environment 232. Protected content 242 is encrypted and may be decrypted via key 263. Protected content 244 may comprise data and/or processes for use by main environment 234 upon verification of the current integrity metrics of main environment 234 or at least the protected core of main environment 234. Protected content 244 is encrypted and may be decrypted via key 265.

Trust verification module 250 comprises logic such as hardware and/or software embedded in firmware to verify current integrity metrics of environments prior to releasing keys such as keys 263 and 265. Keys such as keys 263 and 265 allow corresponding environments to access data and/or processes stored in protected data storage areas of, e.g., hard disks, RAM, flash memory, or other non-volatile and volatile memory, such as protected content 242 and protected content 244. In some embodiments, trusted verification module comprises a TPM such as the TPM described in conjunction with FIG, 1. In some embodiments the trust verification module 250 exists in a partitioned and sequestered processor core and is available to only a single virtual machine over a secure communication channel such as an interpartition bridge by a virtual machine manager or directly by a virtual machine when TPM functions are needed.

In some embodiments, the Trusted verification module 250 replicates services available through a traditional, standalone TPM, such as TPM 190 of FIG. 1. The trusted verification module 250 in some embodiments provides services through an integrity metrics measurer 252, a protected storage accessor 254, protected storage 260, an approved environment identifier 270, and a key generator 272. Integrity metrics measurer 252 may measure current integrity metrics of a runtime environment such as embedded environment 232 and pass the integrity metrics to protected storage accessor 254. Integrity metrics measurer 252 may measure integrity metrics such as software and hardware assignments associated with the runtime environment to generate a summary of the environment that identifies the environment in a substantially unique way. The process of measuring integrity metrics is designed to result in a different measurement if code or hardware configurations of the runtime environment change such as by the introduction of a virus or hardware into the environment. In some embodiments, measurements accommodate insignificant changes to an environment such as the assignment of a different physical or logical block of memory, a different channel of communication, or the like.

Protected storage accessor 254 may receive integrity metrics from integrity metrics measurer 252 and either verify the metrics against metrics in protected storage 260 or store the metrics in protected storage 260. For instance, if approved environment (AE) identifier 270 indicates that a runtime environment, such as embedded environment 232, is an approved environment for storing trusted integrity metrics 262, a key generator 272 may generate key 263 for encrypting protected content 242 and encryption module 258 of protected storage accessor 254 may encrypt key 263 with integrity metrics 262. Protected storage accessor 254 may then store key 263 in protected storage 260.

On the other hand, if AE identifier 270 does not identify embedded environment 232 as an approved environment for measuring trusted integrity metrics 262, decryption module 256 of protected storage accessor 254 may compare the measured integrity metrics for embedded environment 232 against integrity metrics 262 to determine whether to provide embedded environment with key 263. If the current integrity metrics do not match integrity metrics 262, then key 263 may not be returned to embedded environment 232.

Protected storage 260 may comprises registers or other memory to store keys sealed against integrity metrics. In many embodiments, protected storage 260 is not accessible to hardware external to trusted verification module 250. In further embodiments, access to protected storage 260 is substantially limited to accesses via protected storage accessor 254.

Protected storage 260 may comprise registers represented by integrity metrics 262 and 264. In many embodiments, at least one of the registers is designated for usage by a manufacturer and/or not for usage by an OS or other such software.

AE identifier 270 may comprise logic to identify an approved environment such as the MAE described in conjunction with FIG. 1. An approved environment may be an environment that may be created through the introduction of hardware, one or more signals, or the like. In many embodiments, the approved environment may only be accomplished during manufacturer of system 200. In other embodiments, the approved environment may be accomplished after manufacturer or after deployment of system 200.

Key generator 272 may comprise a generator that creates cryptographic keys. For example, key generator 272 may generate 40-bit keys, 128-bit keys, 512-bit keys, or the like to encrypt data and processes for protected content 242 and 244. The keys may be symmetrical or asymmetrical such as public and private keys implemented in many contemporary cryptographic applications.

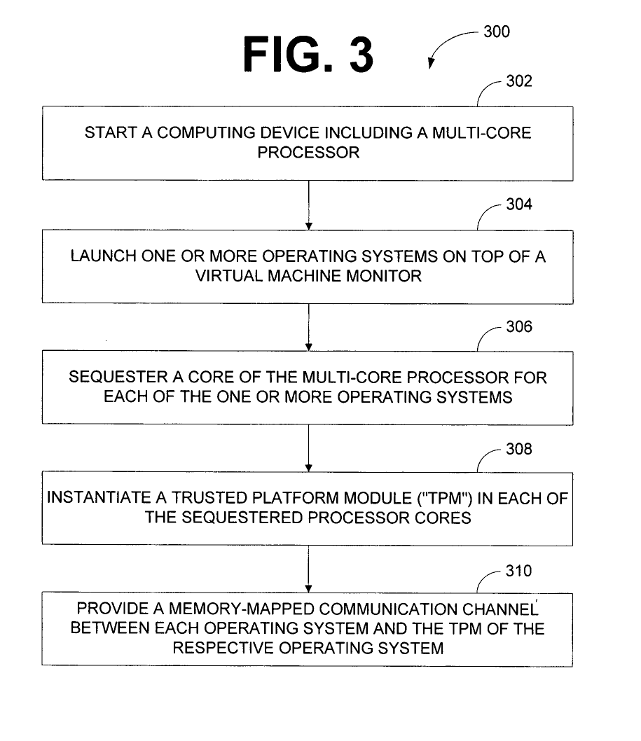

FIG. 3 is a block flow diagram of a method according to an example embodiment. The example method 300 includes starting a computing device including a multi-core processor 302 and launching one or more operating systems on top of a virtual machine monitor 304. The method 300 also includes sequestering a core of the multi-core processor for each of the one or more operating systems 306 and instantiating a trusted platform module (“TPM”) in each of the one of the sequestered processor cores 308. This provides a sequestered processor core that may operate as a TPM for each of the operating systems. Each operating system may also execute within a sequestered processor core mat is separate from the sequestered processor core operating as the TPM for the respective operating system. Some embodiments of the method 300 further include providing a memory-mapped communication channel between each operating system and the TPM of the respective operating system 310. The memory-mapped communication channel may include an IPB. The virtual machine monitor of the method 300, in some embodiments, may be implemented as a firmware virtual machine monitor.

In some embodiments, the method 300, as briefly discussed above, may further include sequestering one or more cores of the multi-core processor for an operating system and launching the operating system within the sequestered cores, wherein the operating system when accessing a TPM communicates with the TPM over the IPB. One or more TPMs instantiated in sequestered processor cores 308 may each have access to a sequestered portion of memory to store and access the sensitive data the TPM utilizes, such as encryption keys and other secret data.

It is emphasized that the Abstract is provided to comply with 37 C.F.R, §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the inventive subject matter require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of the inventive subject matter maybe made without departing from the principles and scope of the inventive subject matter as expressed in the subjoined claims.

What is claimed is:

1. An apparatus comprising:
a multi-core processor coupled to a inter-partition bridge communication channel;
a partition manager to partition one or more of the cores of the multi-core processor according to embedded partition loader code, which when executed, causes the partition manager to:
hide one or more cores of the multi-core processor from other processor cores;
instantiate a trusted partitioned module (“TPM”) in a hidden processor core for each of one or more virtual machines started on the apparatus; and
instantiate a secure communication channel for each partitioned TPM to allow secure communication between a partitioned TPM and a respective virtual machine.

2. The apparatus of claim 1, wherein the partition manager instantiates a TPM instance for each operating system to operate on the apparatus.

3. The apparatus of claim 2, wherein each operating system operates on top of a virtual machine monitor.

4. The apparatus of claim 1, farther comprising:
a BIOS, wherein during boot of the apparatus, the BIOS initializes the partition manager.

5. The apparatus of claim 1, wherein the secure communication channel is the Inter-Partition Bridge (“IPB”).

6. The apparatus of claim 1, further comprising:
a memory; and
wherein the partition manager is further operable to:
for each TPM instantiated in a hidden processor core, sequester a portion of the memory to allow only a processor core of a respective instantiated TPM access to the memory portion; and
hold sensitive data protected by the instantiated TPMs in the respective memory portions.

7. The apparatus of claim 6, wherein the memory is a non-volatile memory.

8. A method comprising:
starting a computing device including a multi-core processor;
launching one or more operating systems on top of a virtual machine monitor;
sequestering a core of the multi-core processor for each of the one or more operating systems;
instantiating a trusted platform module (“TPM”) in each of the sequestered processor cores; and
providing a memory-mapped communication channel between each operating system and the TPM of the respective operating system.

9. The method of claim 8, wherein the virtual machine monitor is a firmware virtual machine monitor.

10. The method of claim 8, wherein the memory-mapped communication channels are Inter-Partition Bridge communication channels.

11. The method of claim 10, further comprising:
sequestering one or more cores of the multi-core processor for an operating system; and
launching the operating system within the sequestered cores, wherein the operating system when accessing a TPM communicates with the TPM over the IPB.

12. The method of claim 8, further comprising;
sequestering at least a portion of memory for each instantiated TPM; and
storing sensitive data of each TPM in respective sequestered memory portions.

13. A machine-readable medium, with instructions thereon, which when executed by a suitably configured machine, cause the machine to perform the method of claim 8.
